(19) United States
(12) Patent Application Publication
(10) Pub. No.: US 2015/0205828 A1
(43) Pub. Date: Jul. 23, 2015

(54) METHODS, SYSTEMS, AND APPARATUS FOR AUTO-COMPLETE SUGGESTION LISTS

(71) Applicants: Christopher Manciero, East Haven, CT (US); Goran Peuc, Dublin 18 (IE); Nick Bartomeli, Shelton, CT (US)

(72) Inventors: Christopher Manciero, East Haven, CT (US); Goran Peuc, Dublin 18 (IE); Nick Bartomeli, Shelton, CT (US)

(73) Assignee: SAP AG, Walldorf (DE)

(21) Appl. No.: 14/160,301

(22) Filed: Jan. 21, 2014

(51) Int. Cl. G06F 17/30; G06F 3/0482

(52) U.S. Cl. CPC G06F 17/30386; G06F 3/0482; G06F 17/30643

(57) ABSTRACT

Methods, systems, and computer program products for generating an auto-complete list are described. A scope of a query and one or more characters of a search term may be obtained. One or more matching terms may be determined for each of one or more search term categories, each of the one or more search term categories being within the query scope, each of the one or more matching terms beginning with the obtained one or more characters. A user selection of at least one of the one or more matching terms may be obtained and a locked search term may be generated based on the user selection.

### FIELD

The present disclosure relates, generally, to user interfaces. In an example embodiment, the disclosure relates to generating auto-complete suggestion lists.

### BACKGROUND

Databases and other data structures are often searched to retrieve relevant data. A user may compose a search query, such as a free form text search, to identify and retrieve data that is relevant to the search. A free form text search may often result in search results that are not relevant to the original query and/or that are related to a different context than the intended context of the query. As a result, a user may need to reformulate a query multiple times or may abandon the search before retrieving relevant results.

### BRIEF DESCRIPTION OF DRAWINGS

The present disclosure is illustrated by way of example and not limitation in the figures of the accompanying drawings, in which like references indicate similar elements and in which:

FIGS. 1A and 1B illustrate schematic diagrams of example systems for generating auto-complete suggestion lists, in accordance with an example embodiment;

FIG. 2 is a block diagram of an example apparatus for generating auto-complete suggestion lists, in accordance with an example embodiment;

FIGS. 3A-3P are representations of an example user interface for entering a search query for a sports player scouting application, in accordance with an example embodiment;

FIGS. 4A and 4B are example representations of the search box and drop down menu of the example user interface of FIG. 3A, in accordance with an example embodiment;

FIG. 4C is an example graphical representation of the handling of search pill overflow within a search box, in accordance with an example embodiment;

FIGS. 5A-5F illustrate representations of the example user interface of FIG. 3A following a numerical entry in the search box, in accordance with an example embodiment;

FIG. 6A is a flowchart illustrating an example method for generating a search query utilizing an auto-complete list generator, in accordance with an example embodiment;

FIG. 6B is an example workflow illustrating an example query generation by a user, in accordance with an example embodiment; and

FIG. 7 is a block diagram of a computer processing system within which a set of instructions, for causing the computer to perform any one or more of the methodologies discussed herein, may be executed.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for generating an auto-complete list are disclosed. In one example embodiment, a search box may be displayed that allows a user to enter text for a query. A search may be conducted for terms that match the entered text and the matching results may be displayed as candidate search terms in columns of a drop down menu, known hereinafter as “search buckets.” A user may select a result from the appropriate bucket to utilize as a search term in the query. A plurality of search terms from different buckets may be combined into a search query that may be used to return matches for the entire search query.

In one example embodiment, an auto-completion search bucket may consist of a search box and placeholders for the search bucket results. As a user enters characters of a term in the search box, a drop down menu may be displayed that displays one or more allowable terms that begin with the entered characters. If the entered characters match allowable terms from multiple search categories, the drop down menu may contain a plurality of search buckets, where each search bucket corresponds to a category. A user may select the desired term from the drop down menu and a “search pill” containing the selected term may be inserted into the search box in place of the entered characters. A search pill may be displayed as a graphical capsule shape and may include a textual representation of the term(s). The term “search pill” is intended to include one or more search terms. Each search term may comprise a plurality of characters (e.g., alphanumeric characters, letters on one or more alphabets, or the like) wherein the term is locked. For example, a locked search is configured so that a user cannot edit the search term(s) and, hence, change or edit or modify one or more of the characters constituting the search term. Thus, once the one or more search terms are defined and locked, they cannot be changed but may be removed or deleted in their entirety.

In one example embodiment, the auto-complete mechanism may be context-based. For example, a search for “apple” may be related to the company by the same name, may be related to the food by the same name, or may be related to the color associated with the term “apple.” The user may select a particular context, such as “food”, to restrict the auto-complete mechanism. The selection may be made from a drop-down menu or via text entry. The auto-complete mechanism would then suggest terms related to the selected context and may present search buckets related to the context. In one example embodiment, the context is automatically inferred from the set of search terms provided by the user. For example, the context “food” may be inferred from the submission of the terms “apple,” “tree,” and “orchard.”

### Multi-Tiered Enterprise Computing Systems

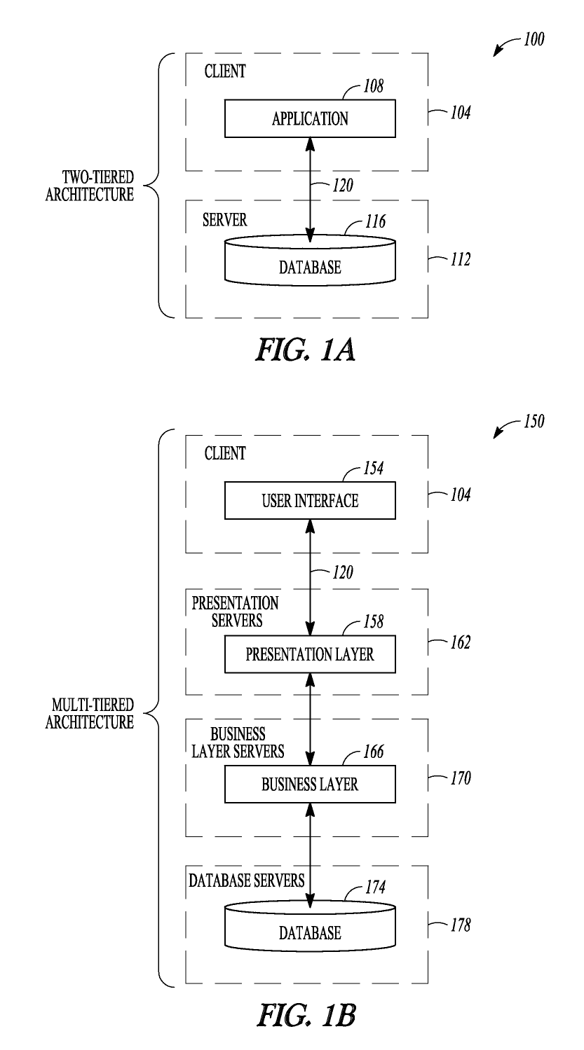

FIGS. 1A and 1B illustrate schematic diagrams of example systems 100, 150 for generating an auto-complete list, in accordance with an example embodiment. Traditional client-server systems may employ a two-tiered architecture such as that illustrated by system 100 in FIG. 1A. Application 108 executed on the client 104 of the two-tiered architecture may be comprised of a monolithic set of program code including a graphical user interface component, presentation logic, business logic and a network interface that enables the client 104 to communicate over a network 120 with one or more servers 112. A database 116 may be maintained on the server 112 that provides non-volatile or “persistent” storage for the data accessed and/or processed by the application 108.

The “business logic” component of the application 108 may represent the core program code of the application 108, i.e., the rules governing the underlying business process (or other functionality) provided by the application 108. The “presentation logic” may describe the specific manner in which the results of the business logic are formatted for display on the user interface. The “database” 116 may include data access logic used by the business logic to store and retrieve data.

In response to limitations associated with the two-tiered client-server architecture, a multi-tiered architecture has been developed, as illustrated in FIG. 1B. In the multi-tiered system 150, the presentation layer 158, business layer 166 and database 174 may be logically separated from the user interface 154 of the application. These layers may be moved off of the client 104 to one or more dedicated servers on the network 120. For example, the presentation layer 158, the business layer 166, and the database 174 may each be maintained on separate servers (e.g., presentation servers 162, business layer servers 170 and database servers 178).

This separation of logical components and the user interface 154 may provide a more flexible and scalable architecture compared to that provided by the two-tiered model of the system 100 in FIG. 1A. For example, the separation may ensure that all clients 104 share a single implementation of business layer 166. If business rules change, changing the current implementation of business layer 166 to a new version may not call for updating any client-side program code. In addition, the presentation layer 158 may be provided, which generates code for a variety of different user interfaces 154, which may be standard browsers.

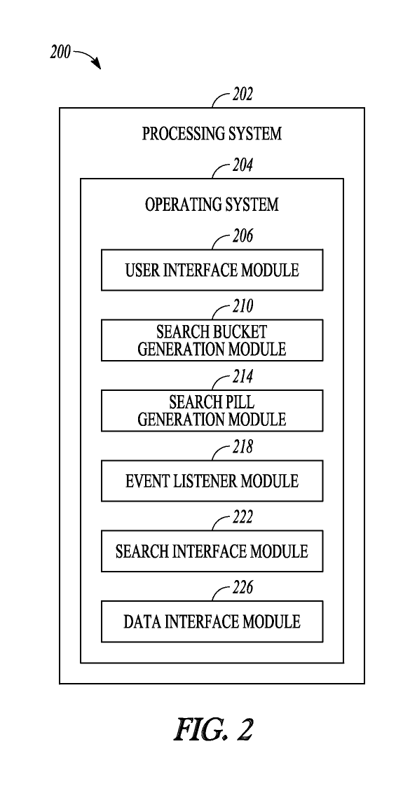

FIG. 2 is a block diagram of an example apparatus 200 for generating auto-complete suggestion lists, in accordance with an example embodiment. For example, the apparatus 200 may be used to generate a set of context-based search pills for a search query.

The apparatus 200 is shown to include a processing system 202 that may be implemented on a server 112, client 104, or other processing device that includes an operating system 204 for executing software instructions. In accordance with an example embodiment, the apparatus 200 may include a user interface module 206, a search bucket generation module 210, a search pill generation module 214, an event listener module 218, and a search interface module 222. In accordance with an example embodiment, the apparatus 200 may include a data interface module 226.

The user interface module 206 may enable a user to enter a search query, select a search scope, conduct a search, and display the associated search results. The user interface module 206 may also enable a user to select terms from search buckets and generate search pills based on the selected terms, as described more fully below.

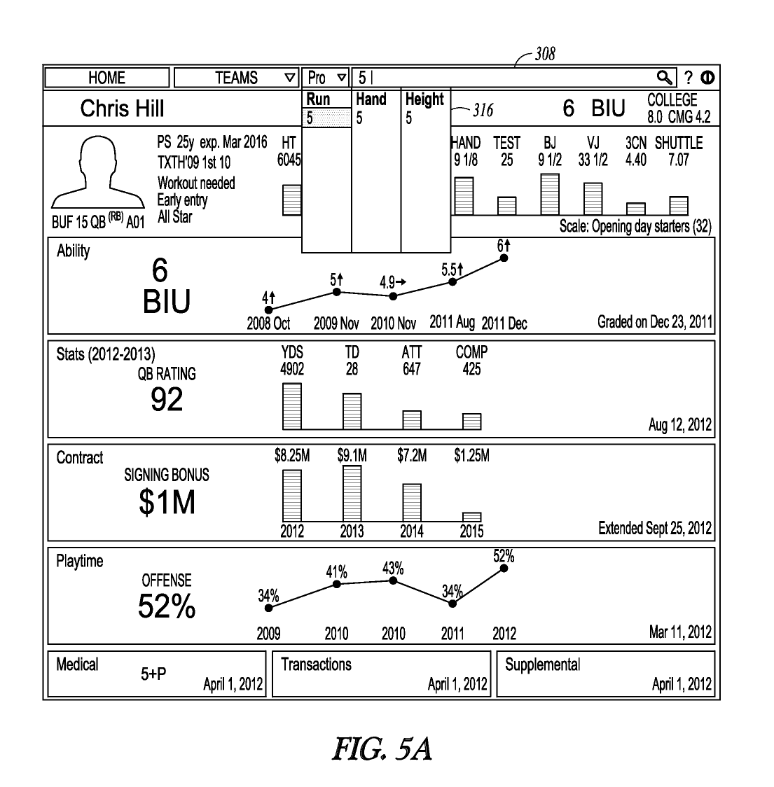

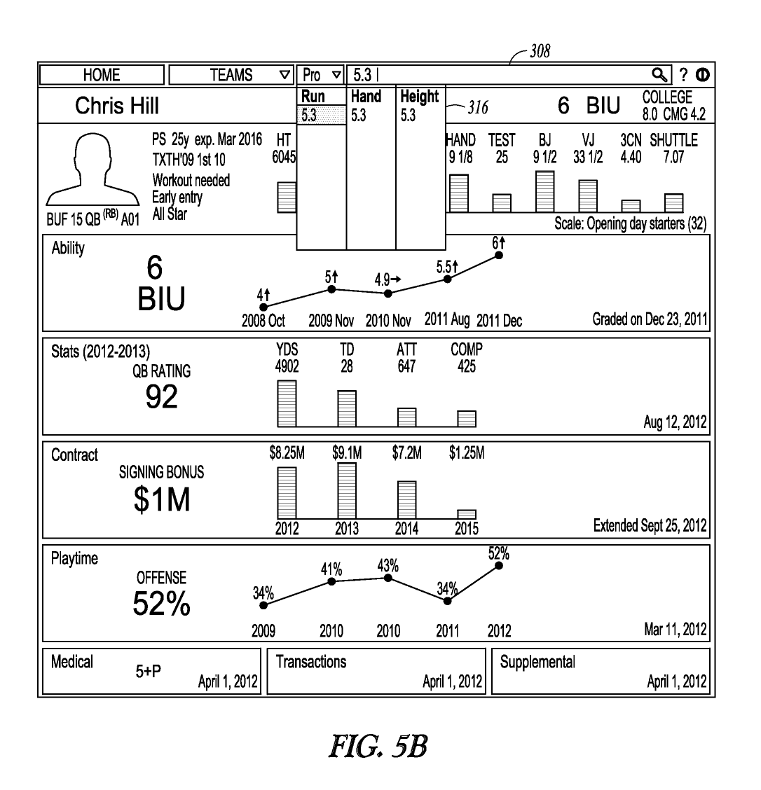

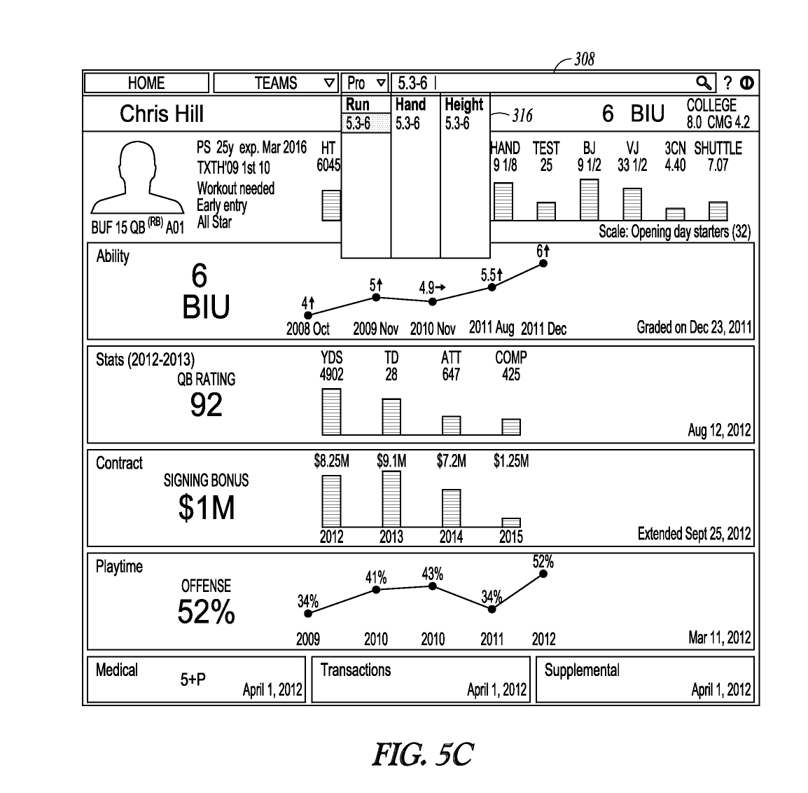

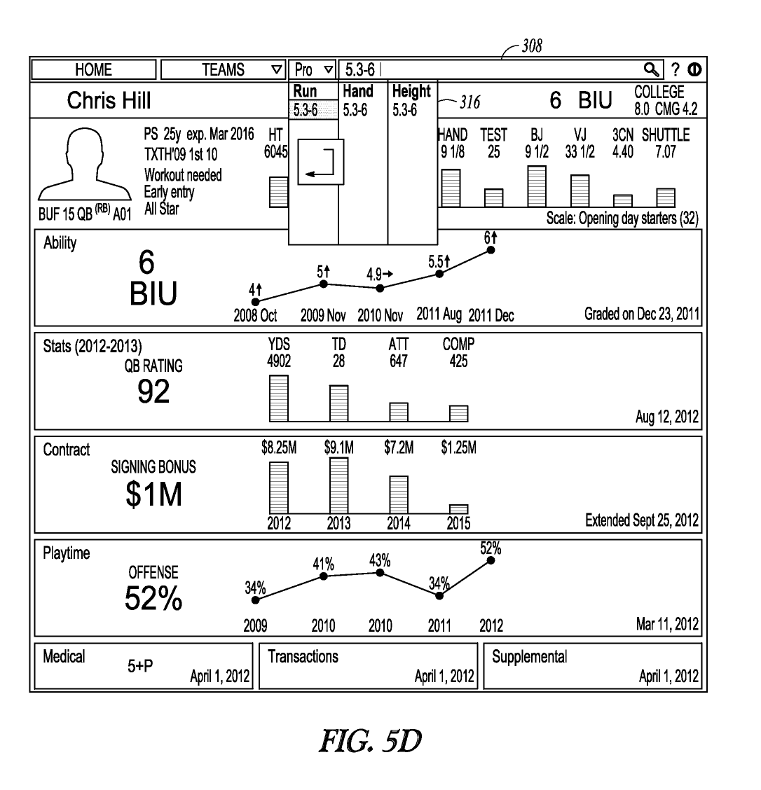

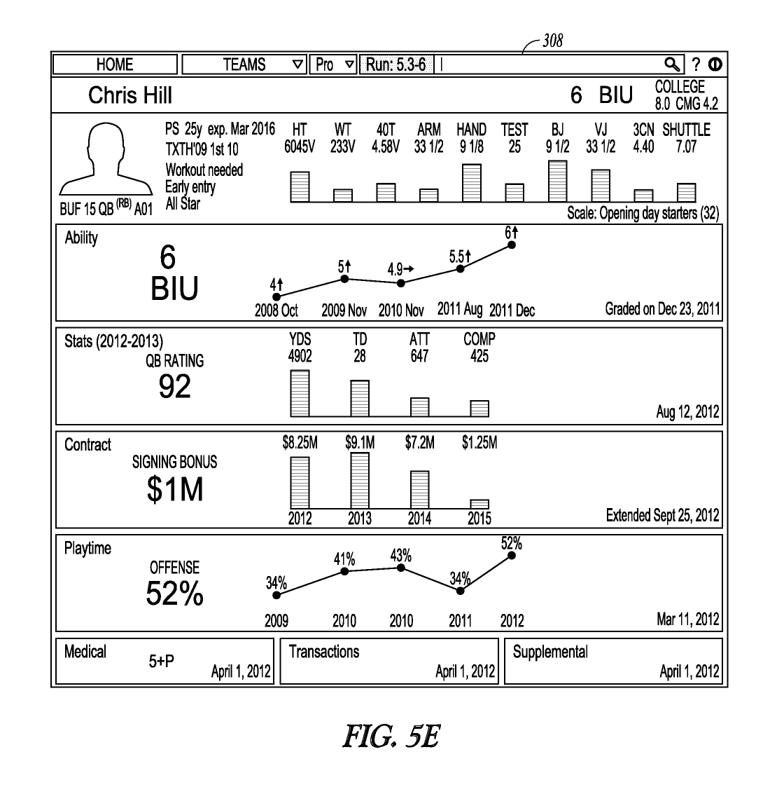

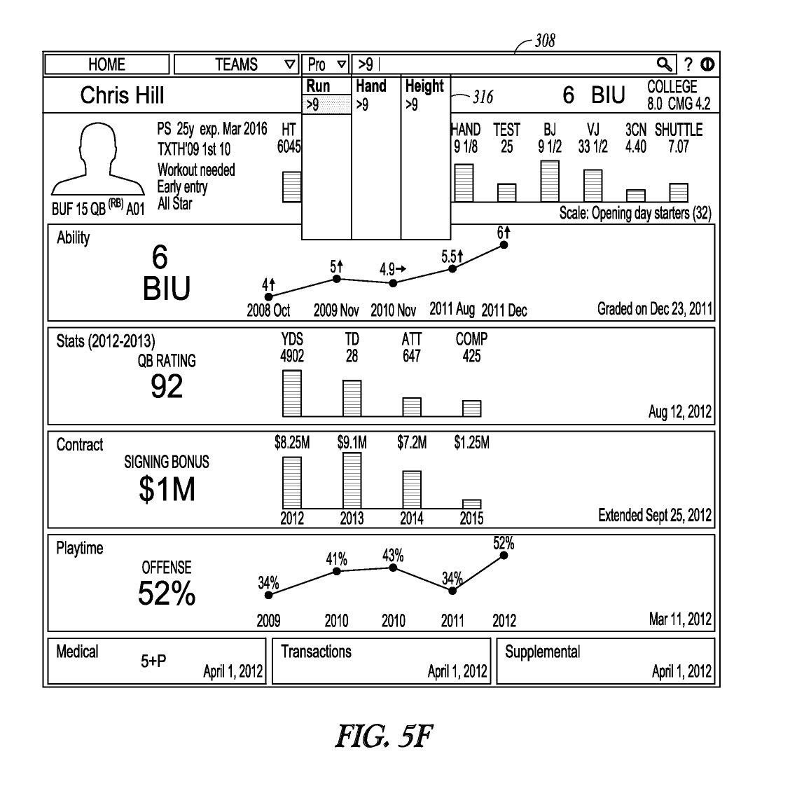

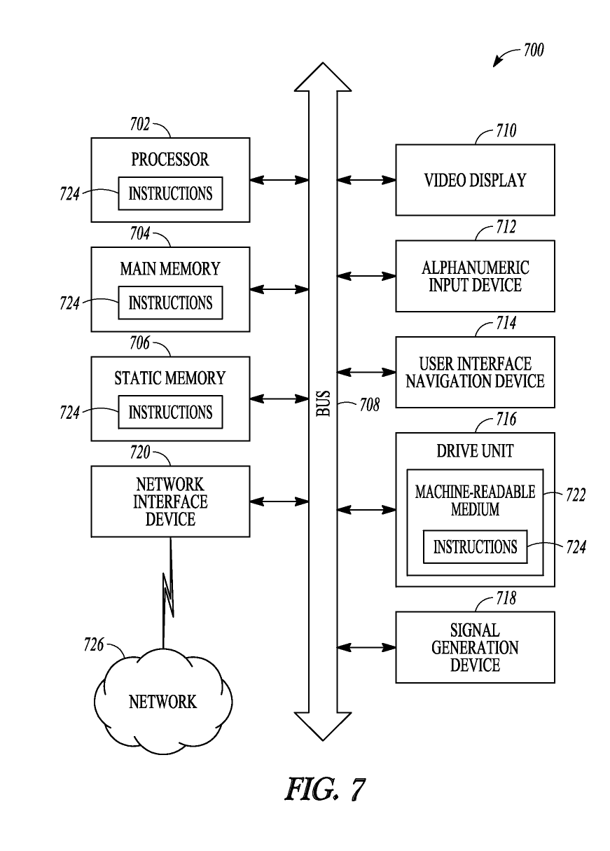

The search bucket generation module 210 may determine search buckets that correspond to free form text entered by a user, as described more fully below in conjunction with FIGS. 5 and 7. The search buckets may allow a user to identify terms that correspond to the intended context of the free form text and to select a term from the search bucket for generation into a search pill.

The search pill generation module 214 may generate a search pill for entry, for example, into a search box. The generated search pill may be based on a user selection from a search bucket. The search pill generation module 214 may process other manipulations of search pills, such as search pill deletion and search pill overflow, as described more fully below.

The event listener module 218 may recognize and parse user input information.

The search interface module 222 may provide an interface to a search service that may search a database or other data structure based on a defined query. The search interface module 222 may provide the search query to a search service and may obtain a search result from the search service.

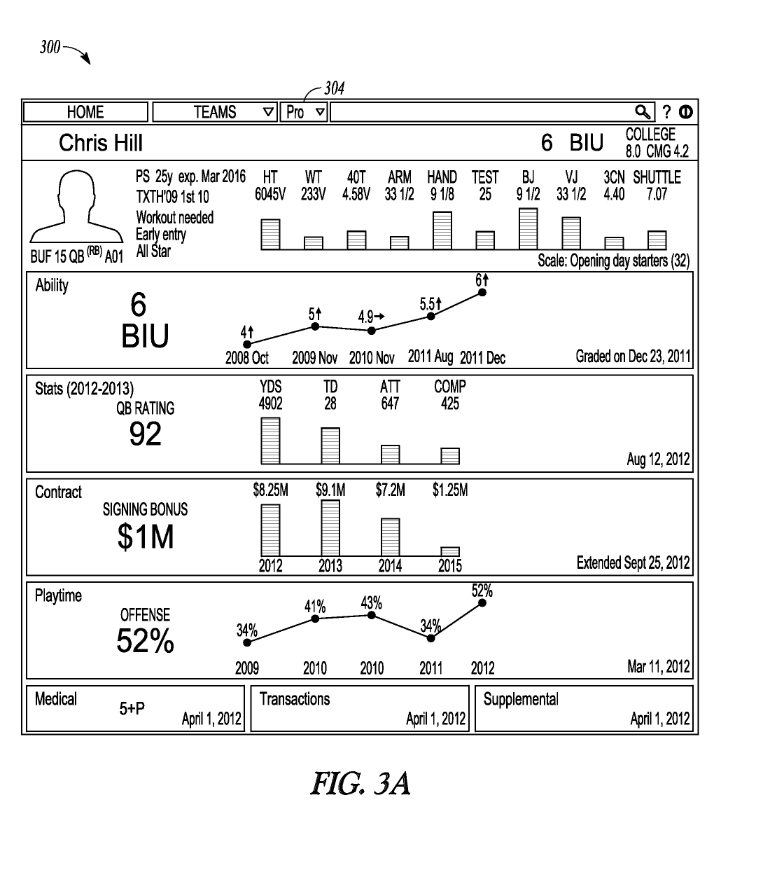

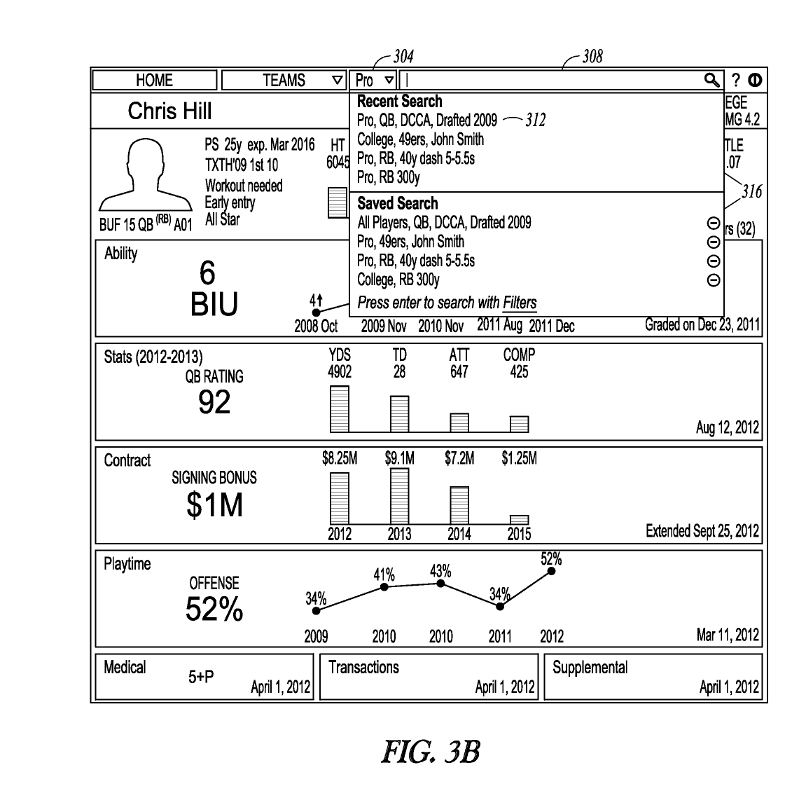

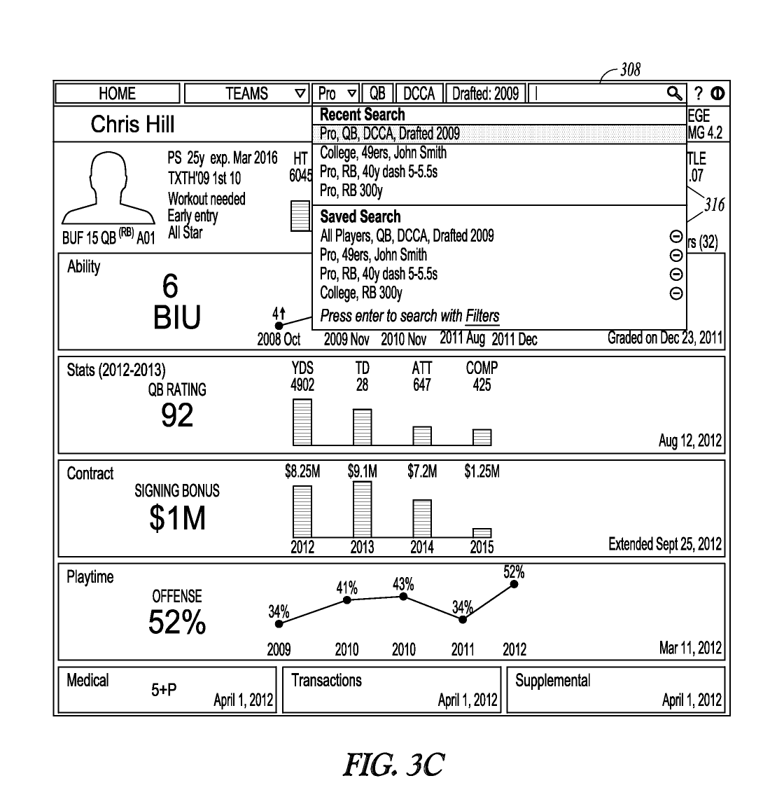

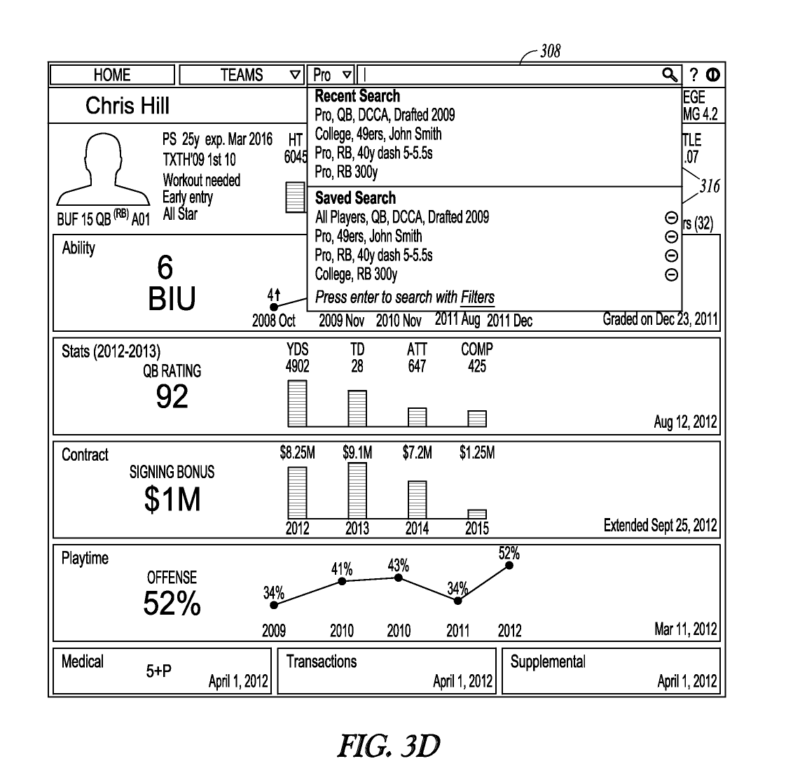

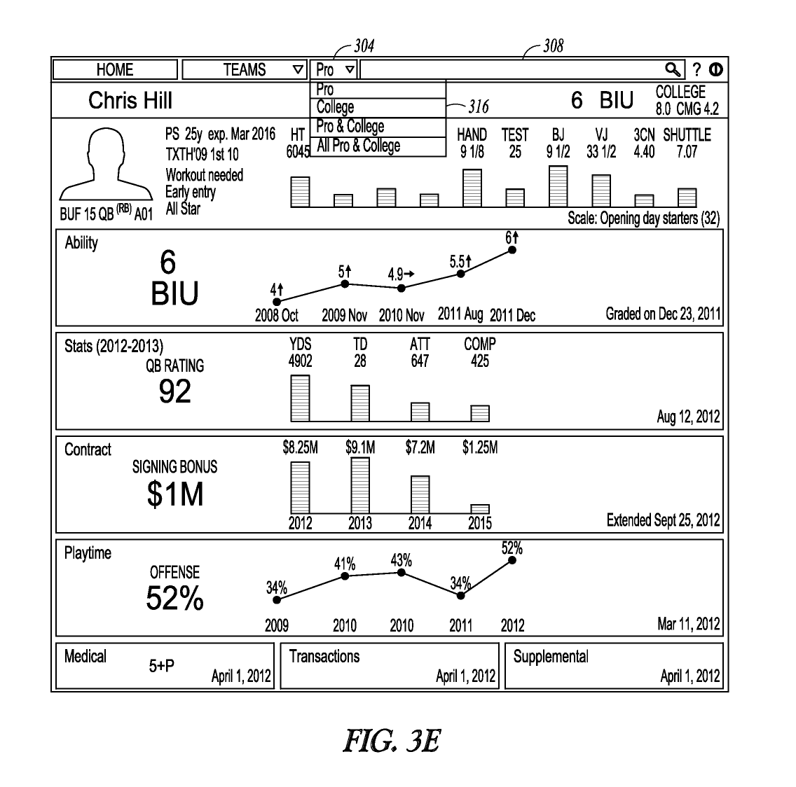

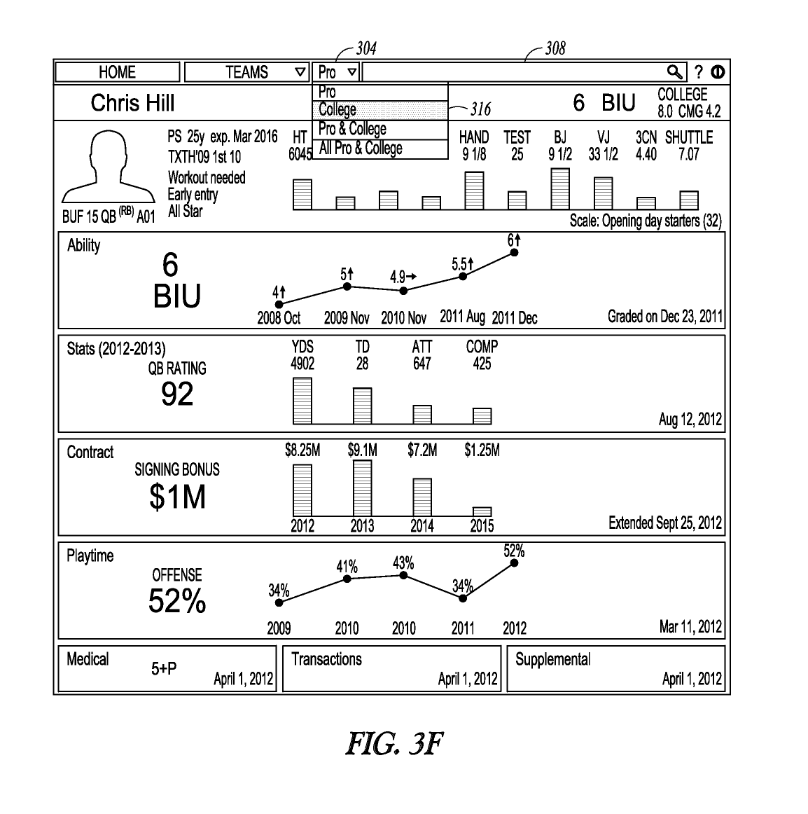

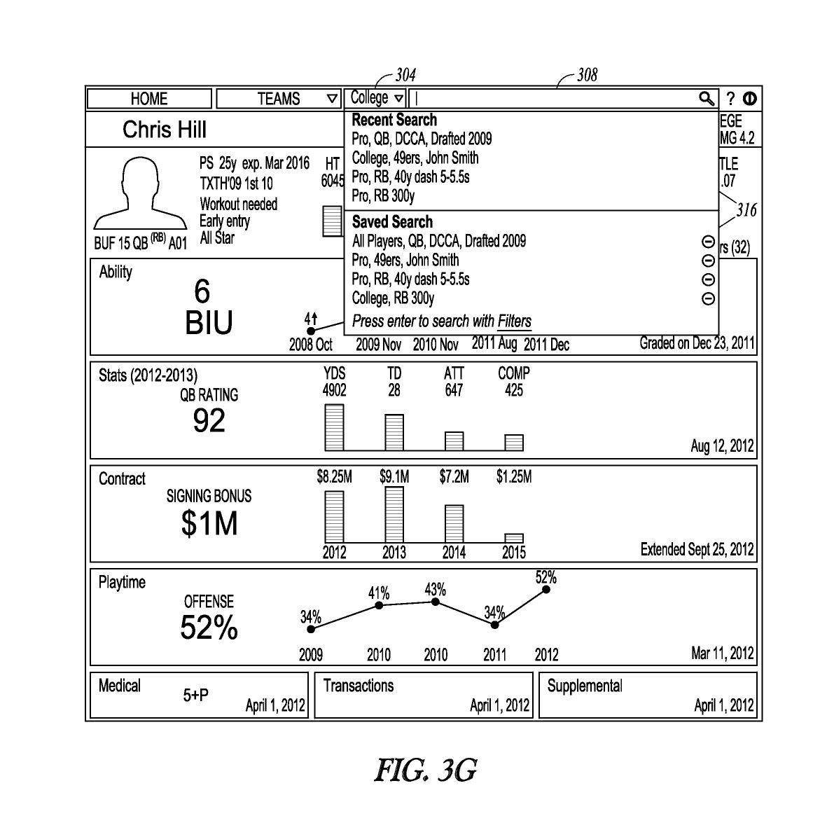

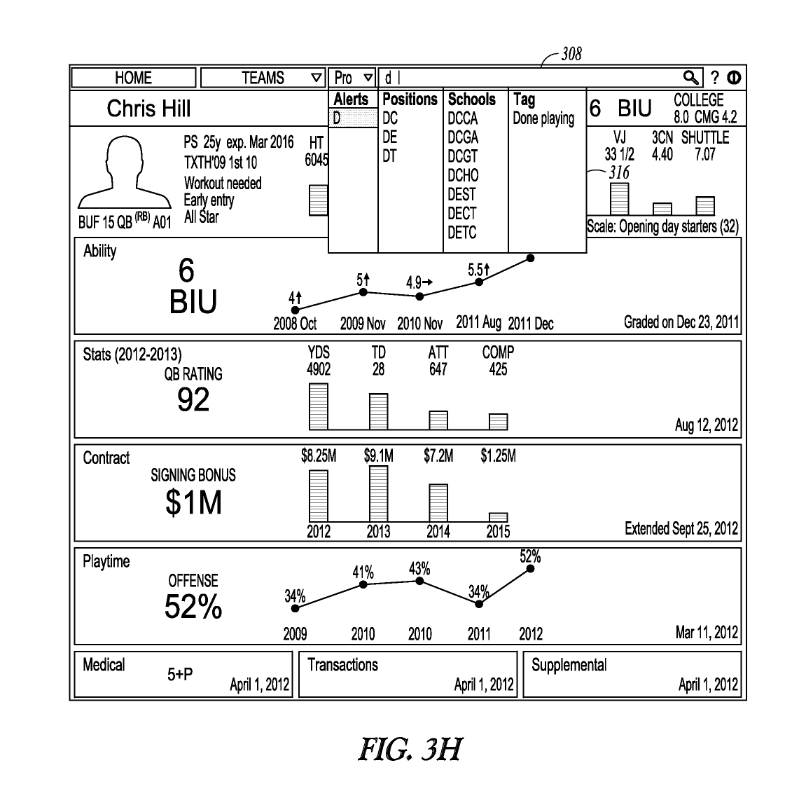

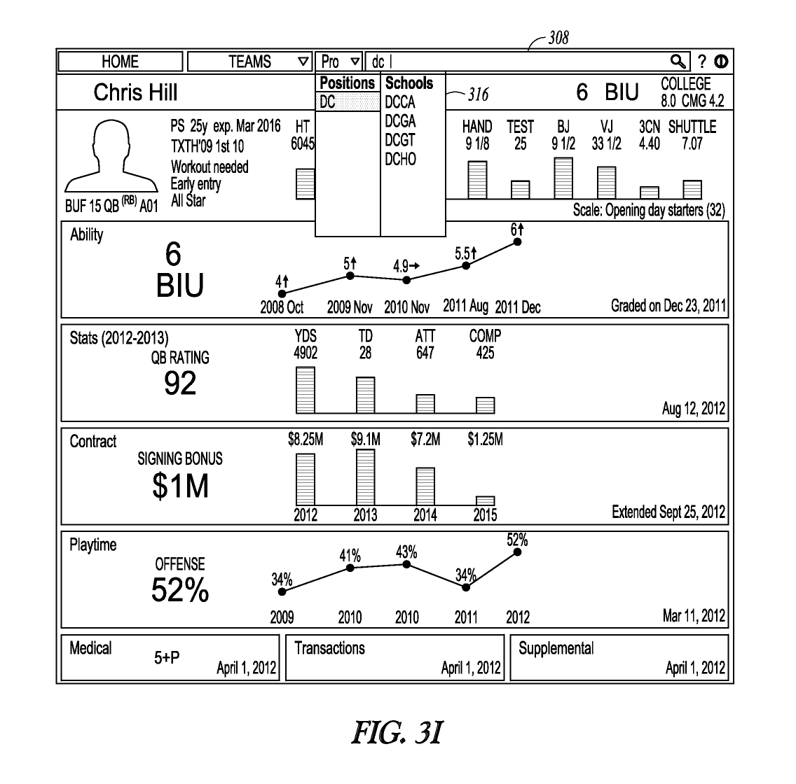

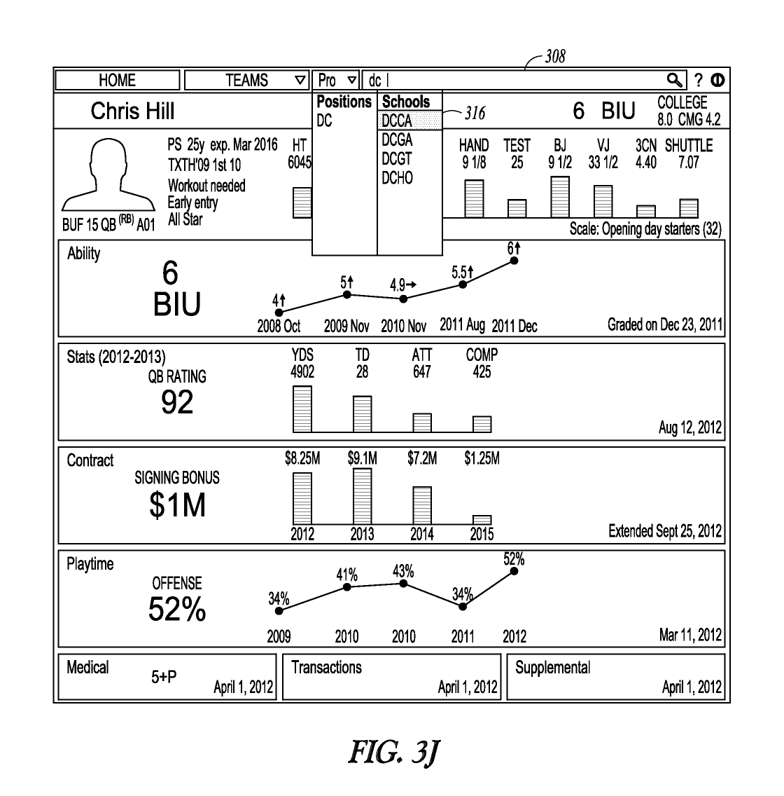

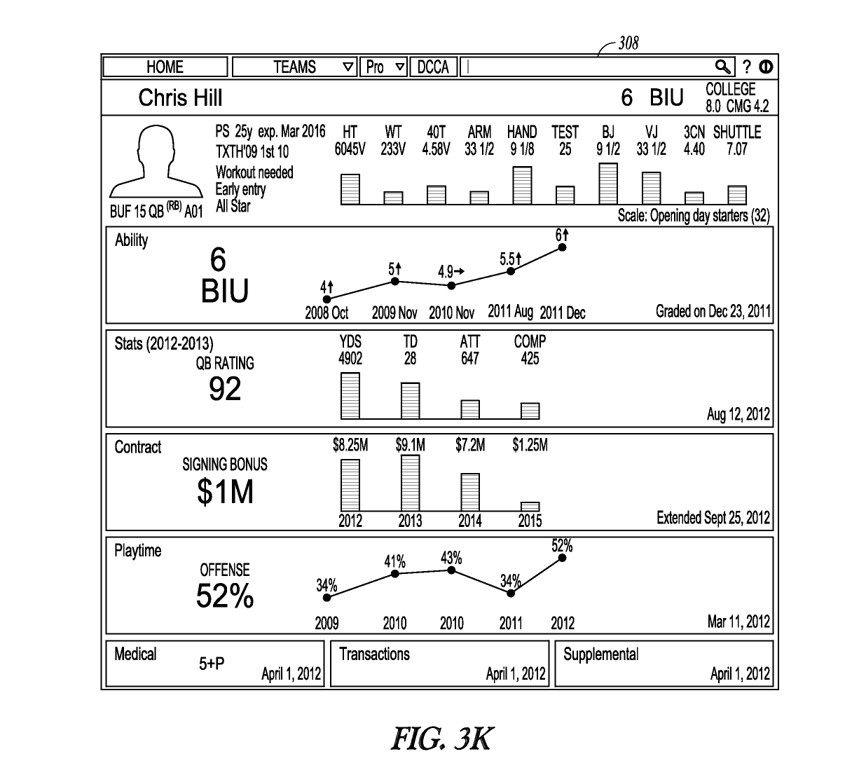

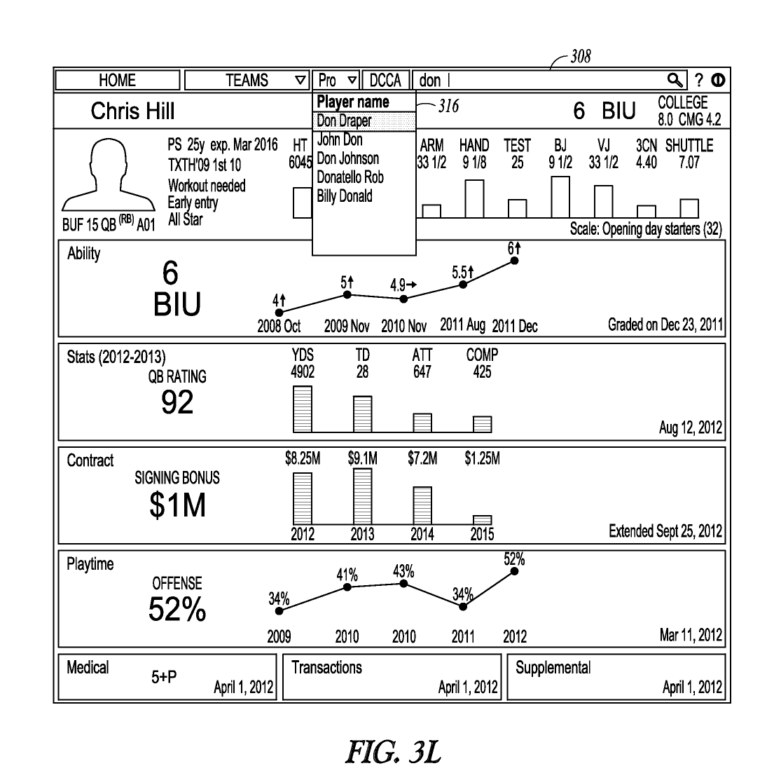

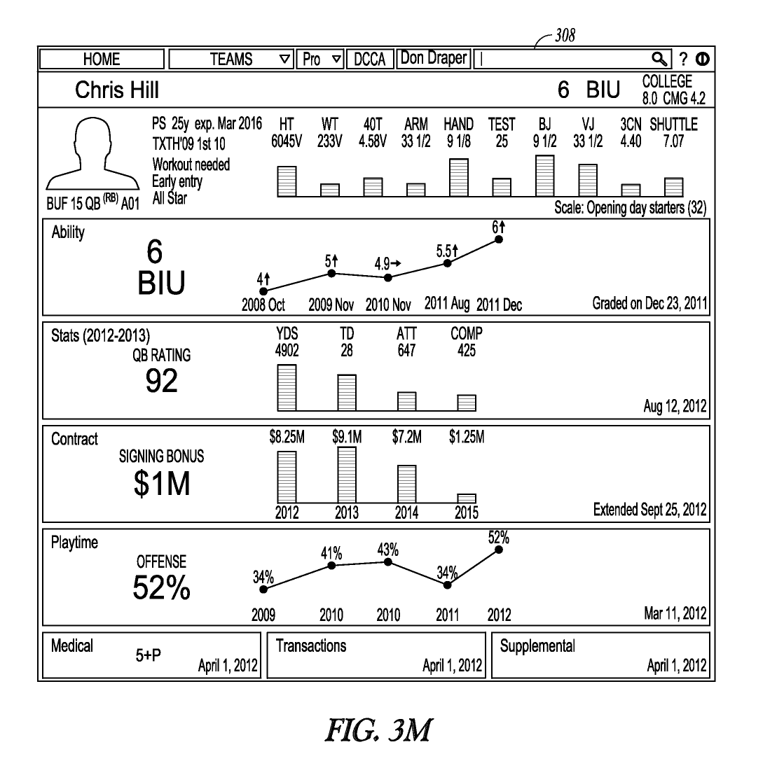

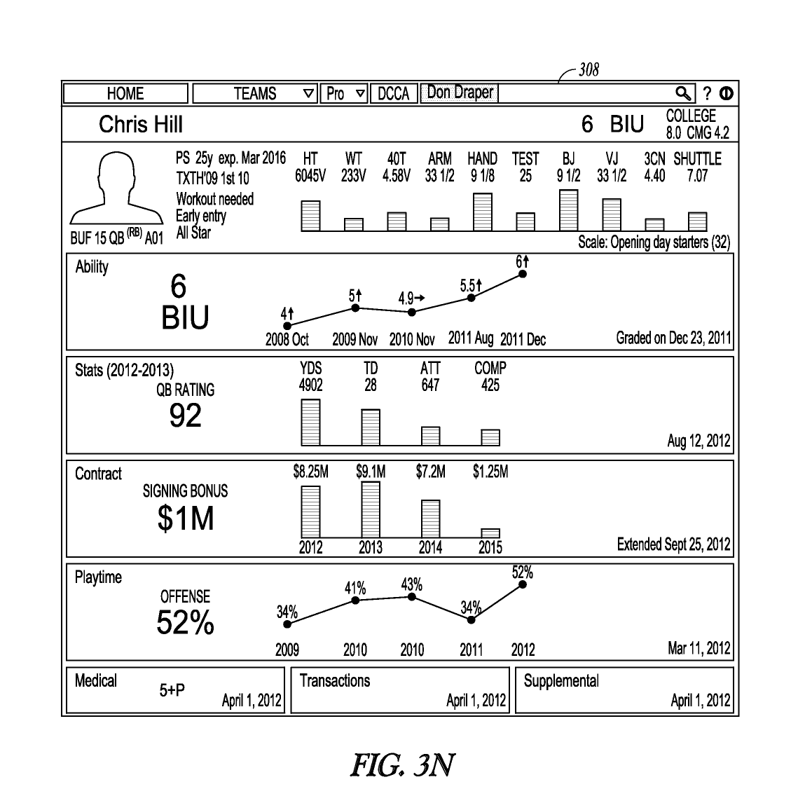

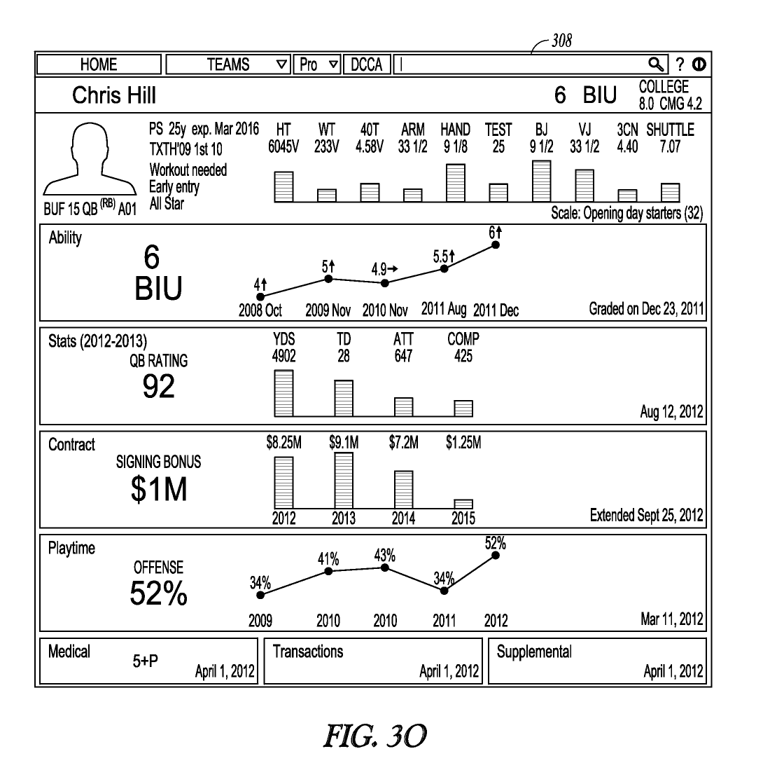

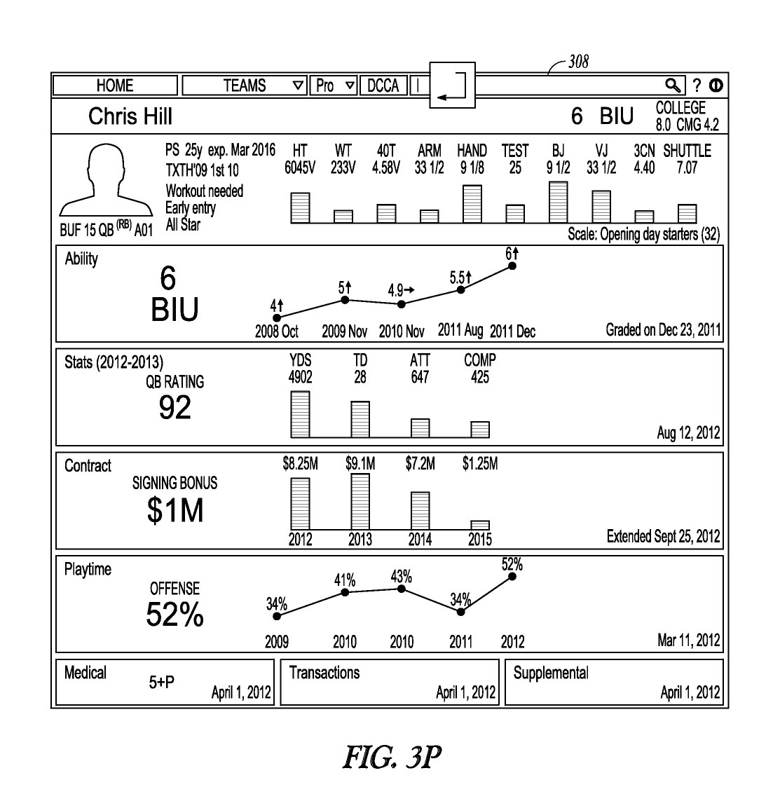

FIG. 3A is a representation of an example user interface 300 for entering a search query for a sports player scouting application, in accordance with an example embodiment. A user may search numerous categories, such as player name, college position, alerts, school(s), National Football League (NFL) team, and the like, for a single point of entry. In one example embodiment, a search query may be:

College Pos=QB with Alerts=B or Alerts=G and School Code=INND

where “College Pos” is the college player's position, “QB” is the quarterback position, and “INND” is Notre Dame University in Indiana.

In one example embodiment, an initial search context may be displayed in a scope selection field 304. For example, professional sports may be selected, as identified by the “PRO” abbreviation in FIG. 3A.

FIG. 3B illustrates the representation of the example user interface 300 FIG. 3A following a user clicking inside a search box 308 using a mouse. In response to clicking inside the search box 308, a list of recent searches and/or saved searches 316 may be displayed. A user may select one of the displayed searches 312 using a mouse or up/down arrow keys. In response, the search pills associated with the selected search will be populated into the search box 308, as illustrated in FIG. 3C.

Each search pill represents a search term, or set of terms, associated with the selected search. For example, the “QB” search pill indicates that a quarterback should be searched for. Pressing the enter key may execute the search using the search pills that reside in the search box 308.

A user may delete one or more of the search pills and/or may add additional search pills. For example, the user may delete the three right-most search pills from the search box 308, displaying only the Pro (Professional) search pill, as illustrated in FIG. 3D. The delete operation may be performed by placing the cursor to the right of the search pill to be deleted and pressing the delete or backspace key.

In one example embodiment, the scope of the search may be changed, as indicated by the down arrow of the scope selection field 304, by selecting the “Pro” search pill with a mouse or by pressing the left arrow key while the “Pro” search pill is selected in the scope selection field 304. In response, a drop down menu 316 presenting the scope options may be displayed, as illustrated in FIG. 3E. A user may select another scope, such as “College”, as illustrated in FIG. 3F, and a list of recent searches and/or saved searches 312 may be displayed, as illustrated in FIG. 3G.

Turning to FIG. 3H, the letter “d” has been entered into the search box 308. In response, a search for terms that start with the letter “d” may be conducted and the matching results may be displayed in a drop down menu 316. The search may be limited to terms that are relevant to the entered characters. For example, if two characters have been entered, terms that contain only one character may be bypassed in the search. In the present example, the letter “d” matches terms corresponding to four categories: 1) Alerts; 2) Positions (“POSITION”); 3) Schools; and 4) Tag. There is one matching term in the first category, three matching terms in the second category, seven matching terms in the third category, and one matching term in the fourth category. By default, the first term may be selected and highlighted. The user may enter more characters to whittle down the number of terms in the drop down menu 316, may select the first term by pressing the enter key, or may highlight another term in the drop down menu 316 and select the highlighted term by pressing the enter key. For example, the user may enter the letter “c” in the search box 308 and the selections may be whittled down, as illustrated in FIG. 3I. It is noted that two search buckets have been deleted since they do not contain any terms beginning with the letters “dc.” As illustrated in FIG. 3J, pressing the right arrow key moves the highlighted selection from one search bucket to another search bucket. As illustrated in FIG. 3K, in response to selecting a term, such as by pressing the enter key, a search pill may be generated from the highlighted selection. In one example embodiment, a search pill is automatically created if the drop down menu 316 contains a single term.

As illustrated in FIG. 3L, the letters “don” have been entered into the search box 308. In response, a search for terms that start with the cited letters may be conducted and the matching results may be displayed in the drop down menu 316. Pressing the enter key generates a search pill based on the name “Don Draper”, as illustrated in FIG. 3M. Pressing the backspace key highlights the last search pill, as illustrated in FIG. 3N, and pressing the backspace key again deletes the last search pill, as illustrated in FIG. 3O. A search using the search pills residing in the search box 308 may be triggered by pressing the enter key, as illustrated in FIG. 3P.

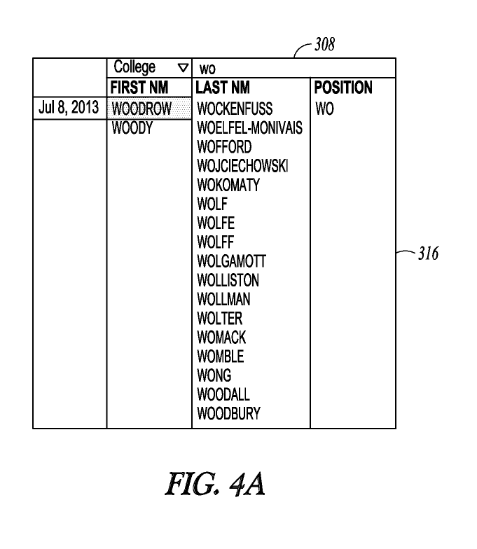

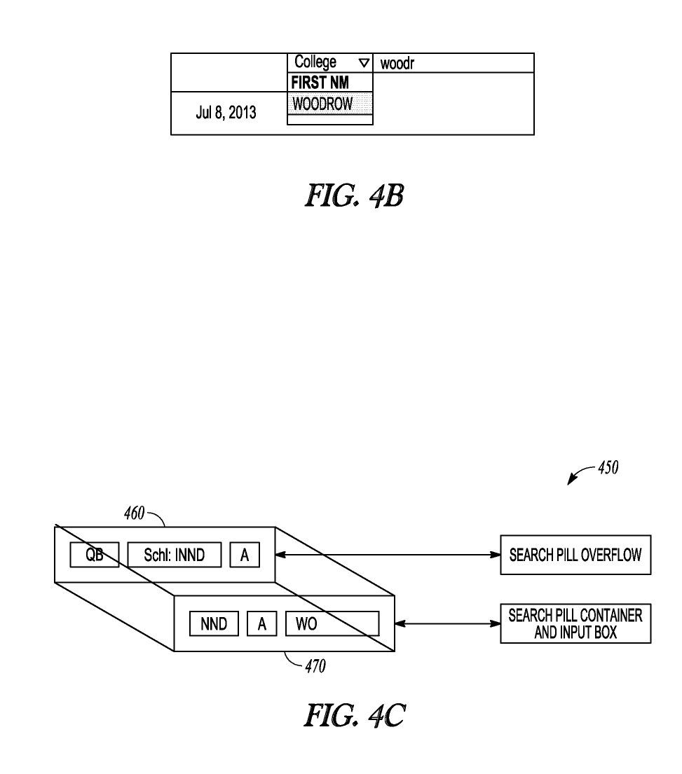

FIGS. 4A and 4B are example representations of the search box 308 and drop down menu 316 of the example user interface 300, in accordance with an example embodiment. As illustrated in FIG. 4A, the letters “WO” have been entered into the search box 308. In response, a search for terms that start with the cited letters may be conducted and the matching results may be displayed in the drop down menu 316. In one example embodiment, the search may be limited to terms that are relevant to the entered characters. In one example embodiment, only search term categories containing terms of a similar count of characters as the count of entered characters may be considered. For example, if two characters have been entered, terms that contain only one character may be bypassed in the search and terms that contain a count of characters that exceed a threshold count may be ignored. For example, if two characters have been entered, terms that contain seven characters may be ignored.

In the present example, the letters “WO” match terms corresponding to three categories: 1) first name (“FIRST NM”); 2) last name (“LAST NM”); and 3) position (“POSITION”). There are two matching terms in the first category, 20 matching terms in the second category, and one matching term in the third category. By default, the first term may be selected and highlighted. The user may enter more characters to whittle down the number of terms in the drop down menu 316, may select the first term by pressing the enter key, or may highlight another term in the drop down menu 316 and select the highlighted term by pressing the enter key or clicking a mouse button. As illustrated in FIG. 4B, the entry of the characters “woodr” has resulted in a single candidate term. In response to selecting a term, a search pill may be generated and entered in the search box 308. In one example embodiment, a search pill is automatically created if the drop down menu 316 contains a single term.

FIG. 4C is an example graphical representation of the handling of search pill overflow within the search box 308, in accordance with an example embodiment. If the number of search pills in a query cannot fit within the bounds of the search box 308, the left-most search pills may be maintained in the search query (as represented by the search pills in the search pill overflow container 460), but are not displayed in the search box 308 (represented by the search pills in the search pill container and input box 470).

In one example embodiment, one or more numbers may be entered in the search box 308. FIGS. 5A and 5B illustrate the representation of the example user interface 300 of FIG. 3A following a numerical entry in the search box 308, in accordance with an example embodiment. For example, as illustrated in FIG. 5A, the number five has been entered. In one example embodiment, in response to an entry of a number, one or more search buckets comprising numbers may be identified and displayed in the drop down menu 316. In one example embodiment, only search buckets that contain at least one numeric value that begins with the entered number(s) may be displayed in the drop down menu 316.

In one example embodiment, a numerical range may be entered, as illustrated in FIG. 5C. For example, two numbers separated by a hyphen may be entered in the search box 308, each number representing a boundary for the search range. In one example embodiment, search buckets comprising numbers may be identified and displayed in the drop down menu 316. In one example embodiment, only search buckets that contain at least one numeric value that is within the entered search range may be displayed in the drop down menu 316. Pressing the enter key may generate a search pill comprising the entered range, as illustrated in FIGS. 5D and 5E.

In one example embodiment, other numeric-based search pills may be generated, including search pills related to a value being greater than a specified value, greater than or equal to a specified value, less than a specified value, less than or equal to a specified value, and the like. FIG. 5F illustrates the category search results for a numerical entry of “>9” in the search box 308.

In one example embodiment, a user is notified if an entered numeric value or numeric range is not within and/or is outside of a predefined range.

In one example embodiment, multiple search pills generated from the same category may be searched as an “OR” function by default. In one example embodiment, multiple search pills generated from the same category may be configured to be searched as an “AND” function.

In one example embodiment, search pills generated from different categories may be searched as an “AND” function by default. In one example embodiment, search pills generated from different categories may be configured to be searched as an “OR” function by default.

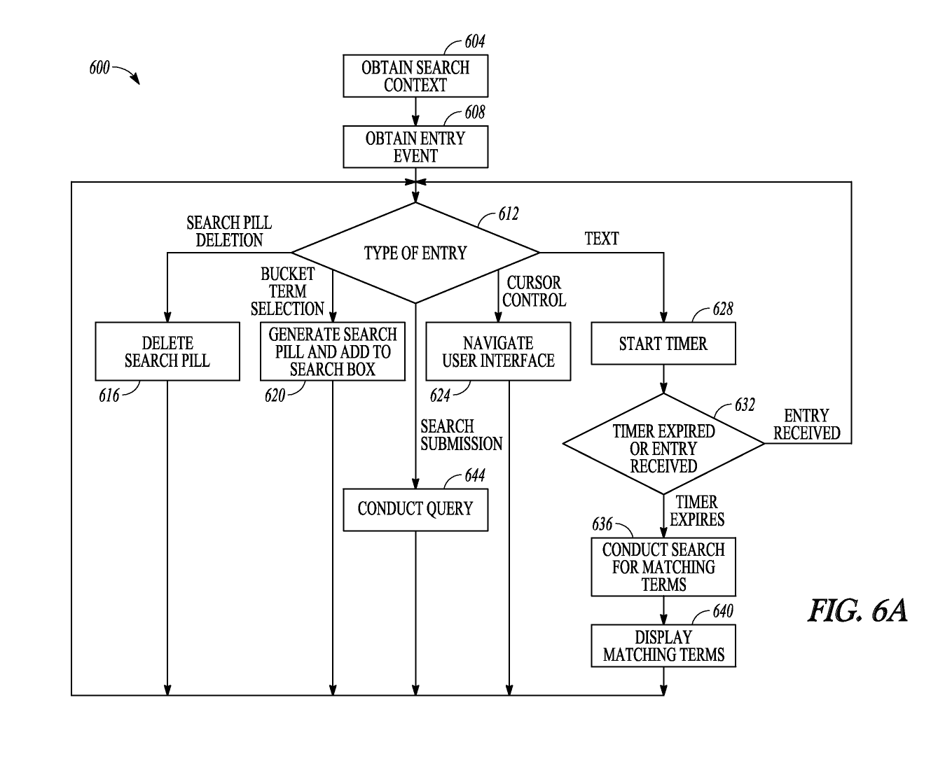

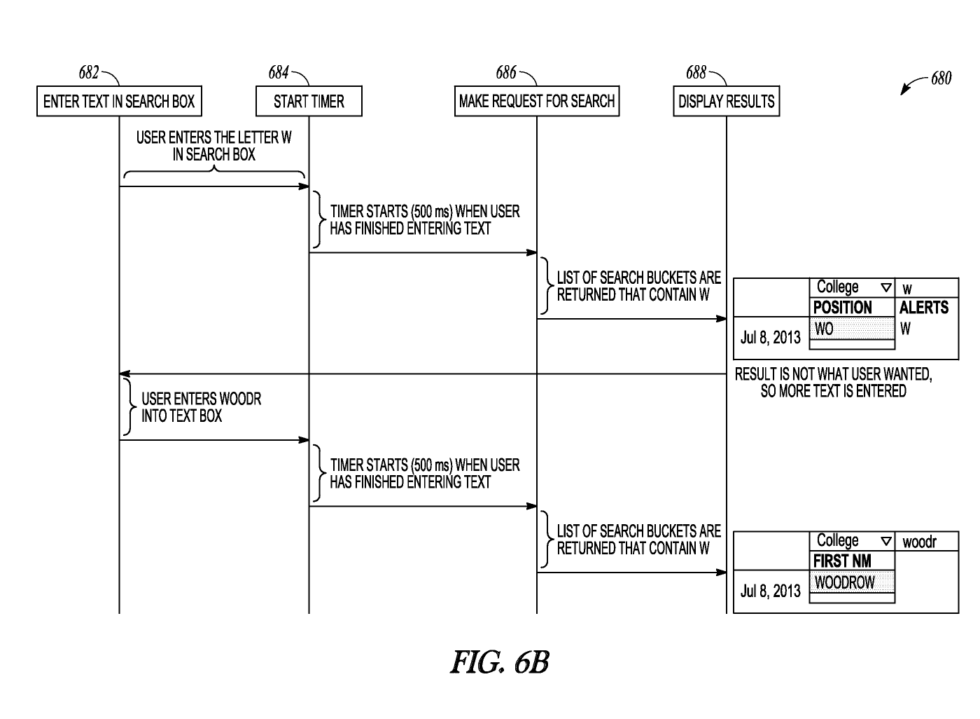

FIG. 6A is a flowchart illustrating an example method 600 for generating a search query utilizing an auto-complete list generator, in accordance with an example embodiment. In one example embodiment, one or more of the operations of method 600 may be performed by the user interface module 206, the search bucket generation module 210, the search pill generation module 214, the event listener module 218, and/or the search interface module 222.

In one example embodiment, a scope or context of a search may be obtained. For example, a selection of a search scope may be obtained from the scope selection field 304 via the user interface module 206 (operation 604).

In one example embodiment, an event listener module 218 listens for an entry being entered by a user via, for example, the search box 308 or a mouse (operation 608). A test may be performed to determine the type of entry (operation 612). For example, the search bucket generation module 210 may perform the cited test.

If the entry is a text entry, a timer may be started (operation 628). The timer may be set to, for example, 500 milliseconds (ms). A test may be performed to determine if the timer has expired or an entry event has been received (operation 632).

If an entry event is received before the timer expires, the method 600 may proceed with operation 612.

If the timer expires before another entry is received, a search may be conducted to determine the search bucket results that match the entered characters (operation 636). For example, the search bucket generation module 210 may conduct a search to determine the search bucket results. The search may be conducted based on a rule base. For example, a rule may define that contexts comprising terms with a count of characters above a threshold are only searched when a defined minimum count of characters have been entered. For example, a rule may define that contexts comprising terms with a count of characters less than the count of characters that have been entered may not be searched.

The search results may be displayed in one or more search buckets according to the category of the search result (operation 640), as described more fully above in conjunction with FIG. 3A.

If the entry is a cursor control, such as an up arrow key, a down arrow key, a left arrow key, or a right arrow key, or a motion of a mouse, the user may navigate the terms in the search bucket(s), may navigate to or from the search box 308, or may navigate to or from the scope selection field 304 (operation 628). The navigation may be performed, for example, via the user interface module 206. An up or down arrow may enable a user to navigate terms in the same search bucket and the left and right arrows may enable a user to navigate between search buckets. If the user presses the up arrow at the top of a search bucket, the user will navigate to the search box 308.

If the entry is a carriage return in the search box 308, a search may be conducted based on the entered query terms (operation 644). In one example embodiment, a search may only be submitted when the search box 308 contains only complete search pills. In one example embodiment, a search may be submitted when the search box 308 contains complete search pills and free form text.

In one example embodiment, the search may be conducted by a search service via the search interface module 222. The search may be a straight-match or a fuzzy-match. A fuzzy-match is a match where, for example, all terms match or only a subset of terms match.

If the entry is the selection of a search term in a search bucket, such as a mouse click of a selected term in a search bucket, a search pill comprising the selected term may be generated and added to the search box 308 (operation 620). For example, the search bucket generation module 210 may generate the search pill and add it to the search box 308. In one example embodiment, the first term in the first search bucket is highlighted by default.

If the entry is a mouse click of a delete icon for a selected pill in the search box 308, the selected search pill may be deleted from the search box 308 (operation 616). The delete icon may initially appear when the mouse is moved over the search pill. In one example embodiment, a user may delete the last entered search pill by navigating to the search box 308 and pressing a delete or backspace key twice.

In one example embodiment, a search box 308 may be in an active mode when being navigated and may be in an inactive mode when not in the process of being navigated. In the active mode, the search box 308 may be expanded (stretched) to be displayed in a larger area (stretch mode), as illustrated in FIG. 3A, and, in the inactive mode, the search box 308 may be compressed to be displayed in a smaller area (shrink mode). The expanded search box 308 may display more search pills than a compressed search box 308.

If a search box 308 contains more search pills than can be displayed, the shift pills will shift or scroll to the left with the oldest search pills being no longer displayed and the newest search pills being displayed in the search box 308, as illustrated in FIG. 3C.

FIG. 6B is an example workflow 680 illustrating an example query generation by a user, in accordance with an example embodiment. A user initially enters the letter “w” in the search box 308 (block 682). The entry of the letter “w” triggers a timer to start (block 684). Since the user has not entered any additional characters after the letter “w”, the timer expires and a search for terms for the search bucket(s) is conducted (block 686). The list of search buckets that begin with the letter “w” are returned and displayed to the user (block 688). The user does not find the intended context (a first name) among the displayed search buckets, so the user enters the additional characters “oodr” (block 682). Following the entry of the last character (“r”), the timer is started (block 684). Since the user has not entered any additional characters after the letter “r”, the timer expires and a search for terms for the search bucket(s) is conducted (block 686). The list of search buckets that contain terms beginning with the letter “woodr” are returned and displayed to the user (block 688). The user finds a search bucket corresponding to the intended context (i.e., first names). It is noted that the intended search bucket was not initially displayed as there were too few characters entered (only a single character was entered) to justify a search of the first name category.

FIG. 7 is a block diagram of a computer processing system within which a set of instructions, for causing the computer to perform any one or more of the methodologies discussed herein, may be executed. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed by software-as-a-service (SaaS), application service provider (ASP), or by utility computing providers. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that, individually or jointly, execute a set (or multiple sets) of instructions to perform any one or more of the methodologies discussed herein.

The example computer processing system 700 includes a processor 702 (e.g., a central processing unit (CPU), a graphics processing unit (GPU) or both), a main memory 704 and static memory 906, which communicate with each other via a bus 908. The computer processing system 700 may further include a video display unit 710 (e.g., a plasma display, a liquid crystal display (LCD) or a cathode ray tube (CRT)). The computer processing system 700 also includes an alphanumeric input device 712 (e.g., a keyboard), a user interface (UI) navigation device 714 (e.g., a mouse, touch screen, or the like), a drive unit 716, a signal generation device 718 (e.g., a speaker), and a network interface device 720.

The drive unit 716 includes machine-readable medium 722 on which is stored one or more sets of instructions 724 and data structures embodying or utilized by any one or more of the methodologies or functions described herein. The instructions 724 may also reside, completely or at least partially, within the main memory 704, static memory 706, and/or within the processor 702 during execution thereof by the computer processing system 700, the main memory 704, static memory 706, and the processor 702 also constituting machine-readable, tangible media 722.

The instructions 724 may further be transmitted or received over network 726 via a network interface device 720 utilizing any one of a number of well-known transfer protocols (e.g., Hypertext Transfer Protocol).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” shall also be taken to include any medium that is capable of storing, encoding or carrying a set of instructions 724 for execution by the computer and that cause the computer to perform any one or more of the methodologies of the present application, or that is capable of storing, encoding or carrying data structures utilized by or associated with such a set of instructions 724. The term “machine-readable medium” shall accordingly be taken to include, but not be limited to, solid-state memories, and optical and magnetic media.

While the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for generating an auto-complete list, the method comprising:
obtaining a scope of a query;
obtaining one or more characters of a search term;
determining one or more matching terms for each of one or more search term categories, each of the one or more search term categories being within the query scope, each of the one or more matching terms beginning with the obtained one or more characters;
obtaining a user selection of at least one of the one or more matching terms; and
generating a locked search term based on the user selection.

2. The computerized method of claim 1, wherein the scope is obtained from a user selection.

3. The computerized method of claim 1, wherein the scope is obtained by analyzing one or more search terms obtained from a user.

4. The computerized method of claim 1, wherein the determining considers only search term categories comprising terms of a similar count of characters as a count of characters of the obtained one or more characters.

5. The computerized method of claim 1, further comprising repeating the determining operation in response to obtaining one or more additional characters of the search term.

6. The computerized method of claim 1, further comprising displaying the one or more matching terms in one or more search buckets, each search bucket corresponding to one of the search term categories.

7. The computerized method of claim 1, further comprising automatically generating a locked search term in response to determining only one matching term in the determining operation.

8. The computerized method of claim 1, wherein the obtained one or more characters correspond to a numerical entry and wherein the determining considers search term categories comprising numerical values.

9. The computerized method of claim 1, wherein a search box is expanded in an active mode and compressed in an inactive mode.

10. The computerized method of claim 1, wherein the locked search term comprises one or more search terms that are locked to preclude editing of the locked search term.

11. An apparatus for generating an auto-complete list, the apparatus comprising:
a processor;
memory to store instructions that, when executed by the processor cause the processor to:
obtain a scope of a query;
obtain one or more characters of a search term;
determine one or more matching terms for each of one or more search term categories, each of the one or more search term categories being within the query scope, each of the one or more matching terms beginning with the obtained one or more characters;
obtain a user selection of at least one of the one or more matching terms; and
generate a locked search term based on the user selection.

12. The apparatus of claim 11, wherein the scope is obtained by analyzing one or more search terms obtained from a user.

13. The apparatus of claim 11, wherein the determining considers only search term categories comprising terms of a similar count of characters as a count of characters of the obtained one or more characters.

14. The apparatus of claim 11, further comprising instructions that, when executed by the processor, cause the processor to repeat the determining operation in response to obtaining one or more additional characters of the search term.

15. The apparatus of claim 11, further comprising instructions that, when executed by the processor, cause the processor to display the one or more matching terms in one or more search buckets, each search bucket corresponding to one of the search term categories.

16. The apparatus of claim 11, further comprising instructions that, when executed by the processor, cause the processor to automatically generate a locked search term in response to determining only one matching term in the determining operation.

17. The apparatus of claim 11, wherein the obtained one or more characters correspond to a numerical entry and wherein the determining considers search term categories comprising numerical values.

18. The apparatus of claim 11, wherein a search box is expanded in an active mode and compressed in an inactive mode.

19. The apparatus of claim 11, wherein the locked search term comprises one or more search terms that are locked to preclude editing of the locked search term.

20. A non-transitory machine-readable storage medium comprising instructions that, when executed by one or more processors of a machine, cause the machine to perform operations comprising:
obtaining a scope of a query;
obtaining one or more characters of a search term;
determining one or more matching terms for each of one or more search term categories, each of the one or more search term categories being within the query scope, each of the one or more matching terms beginning with the obtained one or more characters;
obtaining a user selection of at least one of the one or more matching terms; and
generating a locked search term based on the user selection.
